(19) United States
(12) Patent Application Publication
(10) Pub. No.: US 2026/0172093 A1
(43) Pub. Date: Jun. 18, 2026

(54) OVERLAPPING BASIC SERVICE SET (OBSS) SOUNDING NULL-DATA PACKET (NDP) FORMAT FOR MULTIPLE ACCESS POINT (AP) COOPERATION

(71) Applicant: NEWRACOM, Inc., Irvine, CA (US)

(72) Inventors: Heejung YU, Daejeon (KR); Joonsoo LEE, Irvine, CA (US); Si-Chan NOH, Seoul (KR); Il-Gu LEE, Seoul (KR)

(73) Assignee: NEWRACOM, Inc., Irvine, CA (US)

(21) Appl. No.: 19/406,555

(22) Filed: Dec. 2, 2025

Related U.S. Application Data
(60) Provisional application No. 63/734,699, filed on Dec. 16, 2024.
(60) Provisional application No. 63/741,548, filed on Jan. 3, 2025.

(51) Int. Cl. H04B 7/06; H04B 7/024; H04W 48/08; H04W 84/12

(52) U.S. Cl. CPC H04B 7/0626; H04B 7/024; H04W 48/08; H04W 84/12

(57) ABSTRACT

Disclosed herein is a method performed by a first access point (AP) to perform an overlapping basic service set (OBSS) channel sounding procedure. The method includes transmitting a null data packet announcement (NDPA) frame to cause a second AP operating a second BSS to transmit a null data packet (NDP) frame, determining a transmission scheme that a station (STA) that is associated with the first AP is to use for transmitting a channel state information feedback frame based on information included in the NDP frame transmitted by the second AP, and transmitting a trigger frame to the STA to cause the STA to transmit the channel state information feedback frame, wherein the trigger frame includes an indication of the transmission scheme that the STA is to use for transmitting the channel state information feedback frame.

### CROSS-REFERENCE TO RELATED APPLICATION

This application claims the benefit of U.S. Provisional Application No. 63/741,548, filed Jan. 3, 2025, titled “Overlapping Basic Service Set (OBSS) sounding null-data packet (NDP) format for multi-AP cooperation for an IEEE 802.11bn ultra-high reliability (UHR) Wi-Fi standard”, and U.S. Provisional Application No. 63/734,699, filed Dec. 16, 2024, titled “Overlapping Basic Service Set (OBSS) channel sounding for multi-AP cooperation for an IEEE 802.11bn ultra-high reliability (UHR) Wi-Fi standard,” which are hereby incorporated by reference.

This application is also related to U.S. application Ser. No. 19/323,845 filed Sep. 9, 2025, titled “OVERLAPPING BASIC SERVICE SET (OBSS) CHANNEL SOUNDING PROCEDURE FORMULTIPLE ACCESS POINT (AP) COOPERATION”, which also claims the benefit of U.S. Provisional Application No. 63/734,699, filed Dec. 16, 2024, which are hereby incorporated by reference.

### TECHNICAL FIELD

The present disclosure generally relates to wireless communications, and more specifically, relates to an overlapping basic service set (OBSS) channel sounding procedure.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHz, 6 GHz, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.1ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming.

When multiple access points (APs) are deployed in an environment, the performance of wireless networks (e.g., Wi-Fi network) can be degraded due to limited bandwidth and interference between APs. AP cooperative transmission schemes (also referred to as AP coordination schemes or multi-AP coordination schemes) are being considered as a potential solution to improve wireless network performance (e.g., improve overall throughput) in environments with densely deployed APs. With AP cooperative transmission schemes, multiple APs can cooperate with each other to enhance wireless network performance (e.g., to improve the throughput of stations (STAs) located in areas covered by multiple basic service sets (BSSs)). AP cooperative transmission schemes typically require APs to obtain channel state information from in-BSS STA(s) (STA(s) associated with the AP) and OBSS STA(s) (STA(s) associated with a different AP). APs may perform an OBSS channel sounding procedure to obtain channel state information from in-BSS STAs and OBSS STAs. With existing OBSS channel sounding procedures, an AP decides/dictates the transmission scheme (e.g., modulation coding scheme (MCS) and number of spatial streams) that an in-BSS STA is to use to transmit a compressed beamforming and channel quality information (CB/CQI) frame intended for an OBSS AP, without having any knowledge of the link quality of the link between the STA and the OBSS AP. This means that the selection of the transmission scheme is based on the link quality of the link between the STA and the in-BSS AP (the AP that the STA is associated with). However, in general, the link quality of the link between the STA and the OBSS AP is poorer than the link quality of the link between the STA and the in-BSS AP. As a result, the STA may end up transmitting the CB/CQI frame using a transmission scheme that does not allow the OBSS AP to properly receive and decode the CB/CQI frame. While the STA can transmit the CB/CQI frame using the most robust transmission scheme (e.g., lowest MCS) to ensure that that the OBSS AP can properly receive and decode the frame, this would increase the transmission time and thus degrade performance.

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing a wireless network in which coordinated beamforming can be performed, according to some embodiments.

FIG. 11 is a diagram showing an enhanced overlapping basic service set (OBSS) channel sounding procedure, according to some embodiments.

FIG. 12 is a diagram showing a null data packet announcement (NDPA) frame format, according to some embodiments.

FIG. 13 is a diagram showing a station (STA) info field format, according to some embodiments.

FIG. 14 is a flow diagram showing a method for an access point (AP) to perform an OBSS channel sounding procedure, according to some embodiments.

FIG. 15 is a flow diagram showing a method for a STA to perform an OBSS channel sounding procedure, according to some embodiments.

FIG. 16 is a diagram showing an enhanced overlapping basic service set (OBSS) channel sounding procedure, according to some embodiments.

FIG. 17 is a diagram showing a NDP frame format, according to some embodiments.

FIG. 18 is a diagram showing a field format for a common field of a NDP frame, according to some embodiments.

FIG. 19 is a diagram showing a format of a common field of an OBSS NDP frame that includes five bits for carrying OBSS link quality information or transmission scheme information, according to some embodiments.

FIG. 20 is a diagram showing a format of a common field of an OBSS NDP frame that includes six bits for carrying OBSS link quality information or transmission scheme information, according to some embodiments.

FIG. 21 is a diagram showing a format of a common field of an OBSS NDP frame that includes a bit for indicating that a user-specific field follows the common field, according to some embodiments.

FIG. 22 is a diagram showing a format of a common field of an OBSS NDP frame that includes a bit for indicating that a user-specific field follows the common field, according to some embodiments.

FIG. 23 is a flow diagram showing a method performing an OBSS channel sounding procedure, according to some embodiments.

FIG. 24 is a flow diagram showing a method for performing an OBSS channel sounding procedure, according to some embodiments.

### DETAILED DESCRIPTION

The present disclosure generally relates to wireless communications, and more specifically, relates to an overlapping basic service set (OBSS) channel sounding procedure.

An OBSS channel sounding procedure is a channel sounding procedure that allows access points (APs) or beamformers to obtain channel state information for OBSSs links (e.g., links with STAs or beamformees that are associated with other (different) APs). In the existing OBSS channel sounding procedure, a STA belonging to a first basic service set (BSS) operated by a first AP may transmit a compressed beamforming and channel quality information (CB/CQI) feedback frame that is intended for a second AP operating a second BSS. However, with the existing OBSS channel sounding procedure, the first AP determines/dictates the transmission scheme (e.g., modulation coding scheme (MCS) and/or number of spatial streams) that the STA is to use for transmitting the CB/CQI frame to the second AP, without having any knowledge of the link quality of the link between the STA and the second AP. This means that the selection of the transmission scheme is based on the link quality of the link between the STA and the first AP. However, in general, the link quality of the link between the STA and the second AP (which is an OBSS AP with respect to the STA) is poorer than the link quality of the link between the STA and the first AP (which is an in-BSS AP with respect to the STA). As such, transmitting the CB/CQI frame using the transmission scheme determined/dictated by the first AP may result in the second AP not being able to properly receive and decode the CB/CQI frame. While the STA can use the most robust transmission scheme (e.g., lowest modulation coding scheme (MCS)) to transmit the CB/CQI frame to ensure that the second AP can properly receive and decode the CB/CQI frame, this would increase the transmission time and thus degrade performance.

An enhanced OBSS channel sounding procedure is described herein where the STA providing the channel state information feedback (e.g., the STA that transmits the CB/CQI frame) determines the transmission scheme to use for providing the channel state information feedback to an OBSS AP. The STA may determine the transmission scheme to use based on the link quality (e.g., signal-to-noise ratio (SNR)) of the link between the STA and the OBSS AP. This allows the channel state information feedback to be properly received and decoded by the OBSS AP.

According to some embodiments, a first AP operating a first BSS transmits a first null data packet announcement (NDPA) frame to initiate a channel sounding procedure. The first AP may then transmits a first null data packet (NDP) frame. A first STA that belongs to the first BSS may generate first channel state information for a link between the first STA and the first AP based on the first NDP frame. The first AP may transmit a first trigger frame to cause the first STA to transmit a first channel state information feedback frame. Responsive to receiving the first trigger frame, the first STA may transmit the first channel state information feedback frame to the first AP. The first channel state information feedback frame may include the previously-generated first channel state information for the link between the first STA and the first AP. As a result, the first AP may have channel state information for the link between the first STA and the first AP.

The first AP may then transmit a second NDPA frame to cause a second AP operating a second BSS to transmit a second NDP frame. The second NDPA frame may include an indication of a first transmit power that the second AP is to use for transmitting the second NDP frame. Responsive to receiving the second NDPA frame, the second AP may transmit the second NDP frame using the first transmit power indicated in the second NDPA frame. The first STA may generate second channel state information for a link between the first STA and the second AP based on the second NDP frame. Also, the first STA may determine a first transmission scheme to use for transmitting a second channel state information feedback frame based on a link quality of the link between the first STA and the second AP. The first STA may determine the link quality of the link between the first STA and the second AP based on the first transmit power used by the second AP to transmit the NDP frame (as indicated in the second NDPA frame) and a received signal quality of the second NDP frame. The first AP may transmit a second trigger frame to cause the first STA to transmit the second channel state information feedback frame. Responsive to receiving the second trigger frame, the first STA may transmit the second channel state information feedback frame to the second AP using the determined first transmission scheme. The second channel state information feedback frame may include the previously-generated second channel state information for the link between the first STA and the second AP. As a result, the second AP may have channel state information for the link between the first STA and the second AP.

The second AP may transmit a third NDPA frame to initiate a channel sounding procedure. The second AP may then transmit a third NDP frame. A second STA that belongs to the second BSS may generate third channel state information for a link between the second STA and the second AP based on the third NDP frame. The second AP may transmit a third trigger frame to cause the second STA to transmit a third channel state information feedback frame. Responsive to receiving the third trigger frame, the second STA may transmit the third channel state information feedback frame to the second AP. The third channel state information feedback frame may include the previously-generated third channel state information for the link between the second STA and the second AP. As a result, the second AP may have channel state information for the link between the second STA and the second AP.

The second AP may then transmit a fourth NDPA frame to cause the first AP (operating the first BSS) to transmit a fourth NDP frame. The fourth NDPA frame may include an indication of a second transmit power that the first AP is to use for transmitting the fourth NDP frame. Responsive to receiving the fourth NDPA frame, the first AP may transmit the fourth NDP frame using the second transmit power indicated in the fourth NDPA frame. The second STA may generate fourth channel state information for a link between the second STA and the first AP based on the fourth NDP frame. Also, the second STA may determine a second transmission scheme to use for transmitting a fourth channel state information feedback frame based on a link quality of the link between the second STA and the first AP. The second STA may determine the link quality of the link between the second STA and the first AP based on the second transmit power used by the first AP to transmit the NDP frame (as indicated in the fourth NDPA frame) and a received signal quality of the fourth NDP frame. The second AP may transmit a fourth trigger frame to cause the second STA to transmit a fourth channel state information feedback frame. Responsive to receiving the fourth trigger frame, the second STA may transmit the fourth channel state information feedback frame to the first AP using the determined second transmission scheme. The fourth channel state information feedback frame may include the previously-generated fourth channel state information for the link between the second STA and the first AP. As a result, the first AP may now have channel state information for the link between the second STA and the first AP.

The enhanced OBSS channel sounding procedure described herein allows the STA to determine the transmission scheme to use for transmitting a channel state information feedback frame intended for an OBSS AP based on the link quality of the link between the STA and the OBSS AP. To facilitate this, the in-BSS AP may transmit a NDPA frame with an indication of the transmit power that the OBSS AP is to use (or will use) for transmitting a NDP frame. When the STA receives the NDP frame from the OBSS AP, the STA may determine the link quality of the link between the STA and the OBSS AP based on the transmit power indicated in the NDPA frame and the received signal quality of the NDP frame. Transmitting the channel state information feedback frame intended for the OBSS AP using a transmission scheme that is determined by the STA based on the link quality of the link between the STA and the OBSS AP may increase the probability that the OBSS AP will be able to properly receive and decode the channel state information feedback frame without having to unnecessarily degrade the network performance. This enhanced OBSS channel sounding procedure may be referred to herein as the first enhanced OBSS channel sounding procedure.

Another enhanced OBSS channel sounding procedure is described herein where an OBSS AP may transmit a NDP frame that includes information that allows the in-BSS AP to determine the transmission scheme that a STA associated with the in-BSS AP should use for providing channel state information feedback intended for the OBSS AP. The information included in the NDP frame may be the SNR of the link between the STA and the OBSS AP or the transmission scheme (e.g., MCS and number of spatial streams) that the STA should use for providing channel state information feedback. Having this information allows the in-BSS AP to trigger the in-BSS STA to provide channel state information feedback using a transmission scheme that allows the channel state information feedback to be properly received and decoded by the OBSS AP.

According to some embodiments, a first AP operating a first BSS transmits a first NDPA frame to initiate a channel sounding procedure. The first AP may then transmit a first NDP frame. A first STA that belongs to the first BSS may generate first channel state information for a link between the first STA and the first AP based on the first NDP frame. The first AP may transmit a first trigger frame to cause the first STA to transmit a first channel state information feedback frame. Responsive to receiving the first trigger frame, the first STA may transmit the first channel state information feedback frame to the first AP. The first channel state information feedback frame may include the previously-generated first channel state information for the link between the first STA and the first AP. As a result, the first AP may have channel state information for the link between the first STA and the first AP.

The first AP may then transmit a second NDPA frame to cause a second AP operating a second BSS to transmit a second NDP frame. Responsive to receiving the second NDPA frame, the second AP may transmit the second NDP frame, wherein the second NDP frame includes information that the first AP can use to determine a first transmission scheme that the first STA is to use for transmitting a second channel state information feedback frame. The information included in the second NDP frame may include the SNR of the link between the first STA and the second AP or the transmission scheme that the first STA is to use for transmitting the second channel state information feedback frame. The second AP may determine the information (e.g., SNR or transmission scheme) to include in the second NDP frame based on the first channel state information feedback frame transmitted by the first STA. The first STA may generate second channel state information for a link between the first STA and the second AP based on the second NDP frame. The first AP may determine the first transmission scheme that the first STA should use to transmit the second channel state information feedback frame based on the information included in the second NDP frame. The first AP may transmit a second trigger frame to cause the first STA to transmit the second channel state information feedback frame, wherein the second trigger frame includes an indication of the determined first transmission scheme. Responsive to receiving the second trigger frame, the first STA may transmit the second channel state information feedback frame to the second AP using the first transmission scheme (indicated in the second trigger frame). The second channel state information feedback frame may include the previously-generated second channel state information for the link between the first STA and the second AP. As a result, the second AP may have channel state information for the link between the first STA and the second AP.

The second AP may transmit a third NDPA frame to initiate a channel sounding procedure. The second AP may then transmit a third NDP frame. A second STA that belongs to the second BSS may generate third channel state information for a link between the second STA and the second AP based on the third NDP frame. The second AP may transmit a third trigger frame to cause the second STA to transmit a third channel state information feedback frame. Responsive to receiving the third trigger frame, the second STA may transmit the third channel state information feedback frame to the second AP. The third channel state information feedback frame may include the previously-generated third channel state information for the link between the second STA and the second AP. As a result, the second AP may have channel state information for the link between the second STA and the second AP.

The second AP may then transmit a fourth NDPA frame to cause the first AP (operating the first BSS) to transmit a fourth NDP frame. Responsive to receiving the fourth NDPA frame, the first AP may transmit the fourth NDP frame, wherein the fourth NDP frame includes information that the second AP can use to determine a second transmission scheme that the second STA is to use for transmitting a fourth channel state information feedback frame. The information included in the fourth NDP frame may include the SNR of the link between the second STA and the first AP or the transmission scheme that the second STA is to use for transmitting the fourth channel state information feedback frame. The first AP may determine the information (e.g., SNR or transmission scheme) to include in the fourth NDP frame based on the third channel state information feedback frame transmitted by the second STA. The second STA may generate fourth channel state information for a link between the second STA and the first AP based on the fourth NDP frame. The second AP may determine the second transmission scheme that the second STA should use to transmit the fourth channel state information feedback frame based on the information included in the fourth NDP frame. The second AP may transmit a fourth trigger frame to cause the second STA to transmit the fourth channel state information feedback frame, wherein the fourth trigger frame includes an indication of the determined second transmission scheme. Responsive to receiving the fourth trigger frame, the second STA may transmit the fourth channel state information feedback frame to the first AP using the second transmission scheme (indicated in the fourth trigger frame). The fourth channel state information feedback frame may include the previously-generated fourth channel state information for the link between the second STA and the first AP. As a result, the first AP may have channel state information for the link between the second STA and the first AP.

The enhanced OBSS channel sounding procedure described herein allows an in-BSS AP to determine the transmission scheme that an in-BSS STA is to use for transmitting a channel state information feedback frame intended for an OBSS AP. To facilitate this, the OBSS AP may transmit a NDP frame with information that the in-BSS AP can use to determine the transmission scheme that the in-BSS STA should use. This information may be the SNR of the link between the in-BSS STA and the OBSS AP. The in-BSS AP may then transmit a trigger frame to the in-BSS STA to cause the in-BSS STA to transmit a channel state information feedback frame, where the trigger frame includes an indication of the determined transmission scheme. The in-BSS STA may then transmit the channel state information feedback frame using the transmission scheme indicated in the trigger frame. Allowing the in-BSS AP determine the transmission scheme that the in-BSS STA is to use for transmitting the channel state information feedback frame based on information provided by the OBSS AP increases the probability that the OBSS AP will be able to properly receive and decode the channel state information feedback frame without having to unnecessarily degrade the network performance. This enhanced OBSS channel sounding procedure may be referred to herein as the second enhanced OBSS channel sounding procedure.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

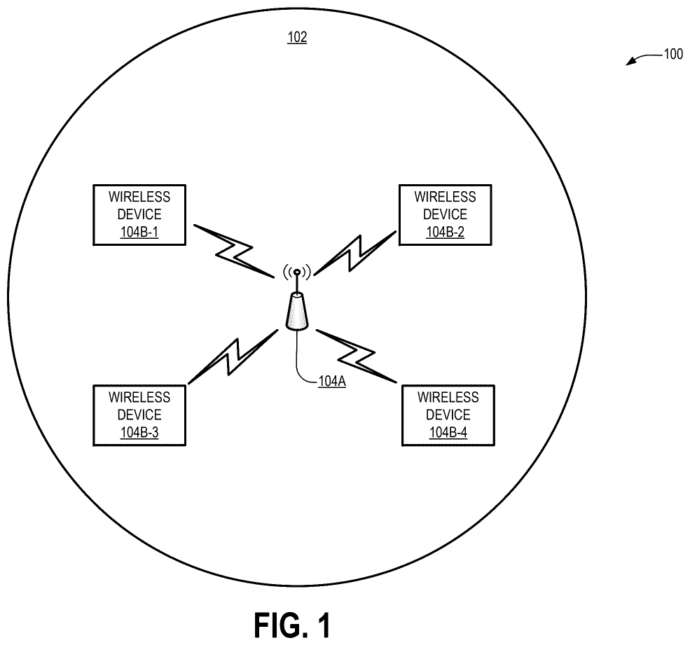

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for ease of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

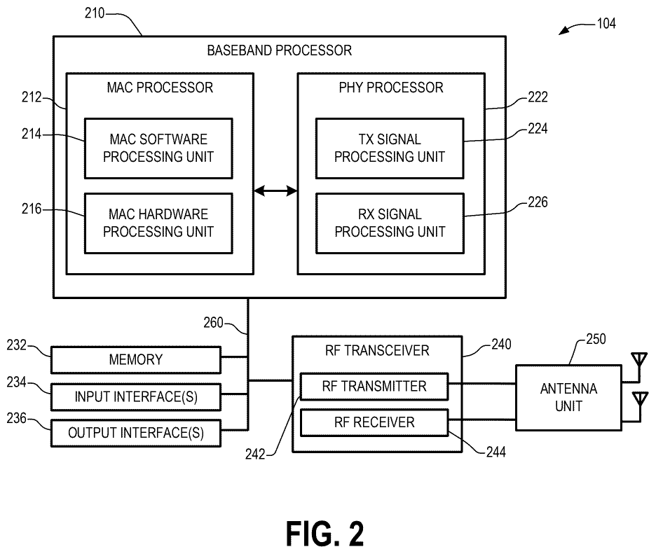

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

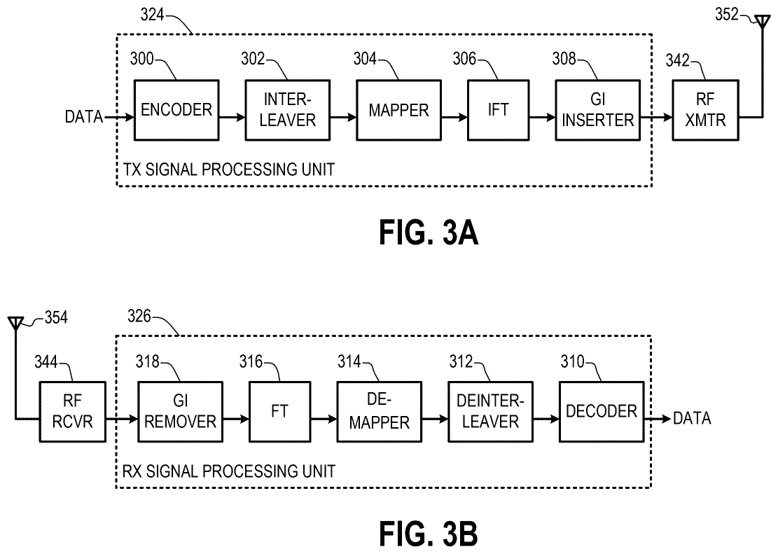

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHz, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

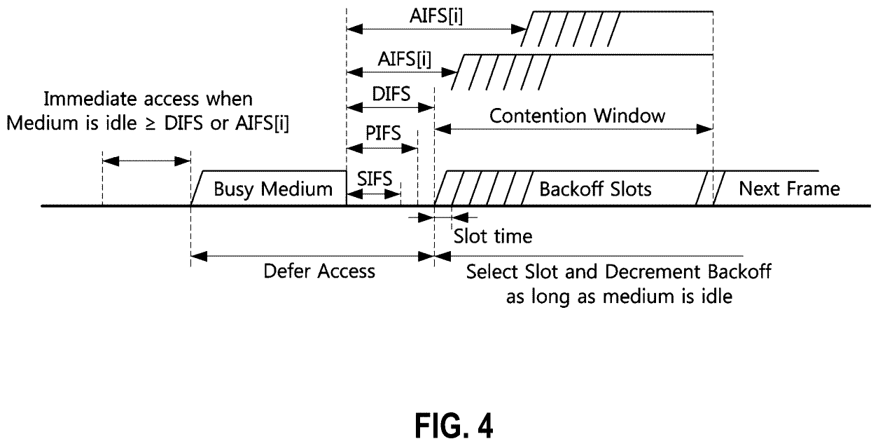

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QoS) functionality (that is, a QoS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

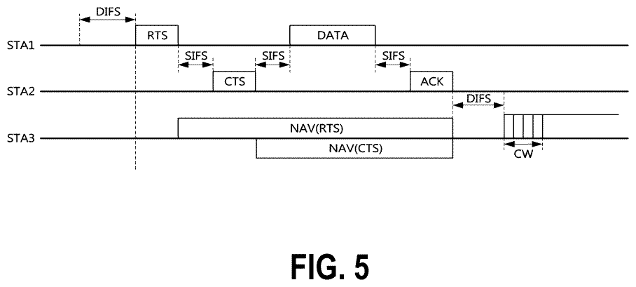

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 does not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period elapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

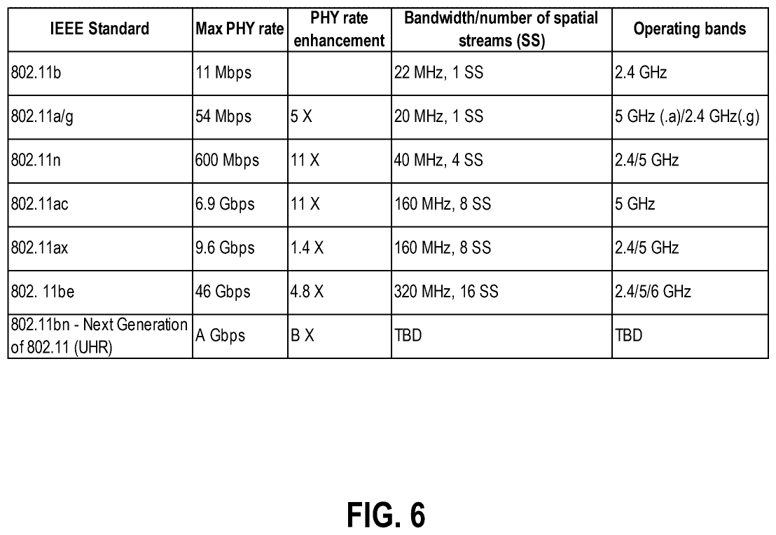

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHz), aggregated PPDU (A-PPDU), enhanced multi-link single-radio (eMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHz) for IEEE 802.11be, more than 1 GHz of additional unlicensed spectrum is likely to be available because the 6 GHz band (5.925-7.125 GHz) is being considered for unlicensed use. This would allow APs and STAs to become tri-band devices. Larger than 160 MHz data transmissions (e.g., 320 MHz or 640 MHz) could be considered to increase the maximum PHY rate. For example, 320 MHz or 160+160MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

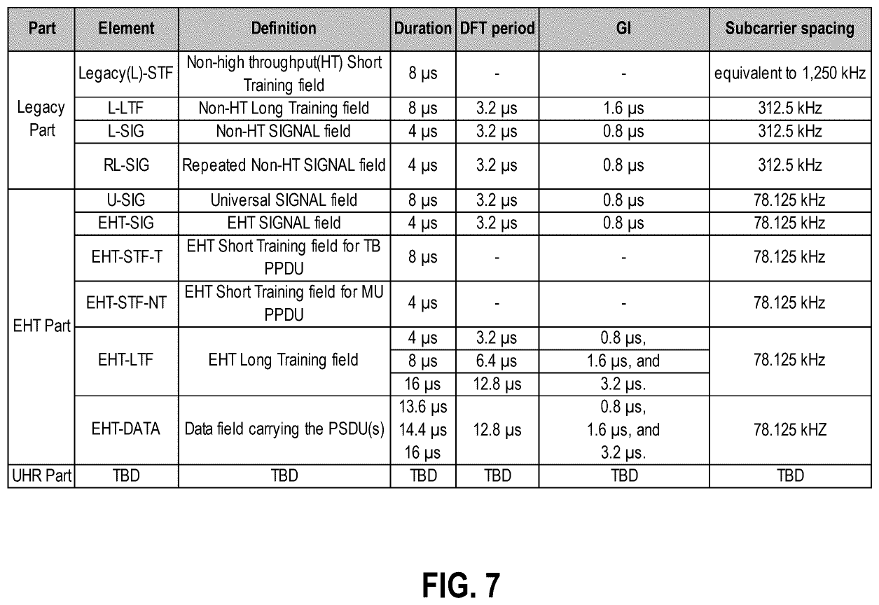

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

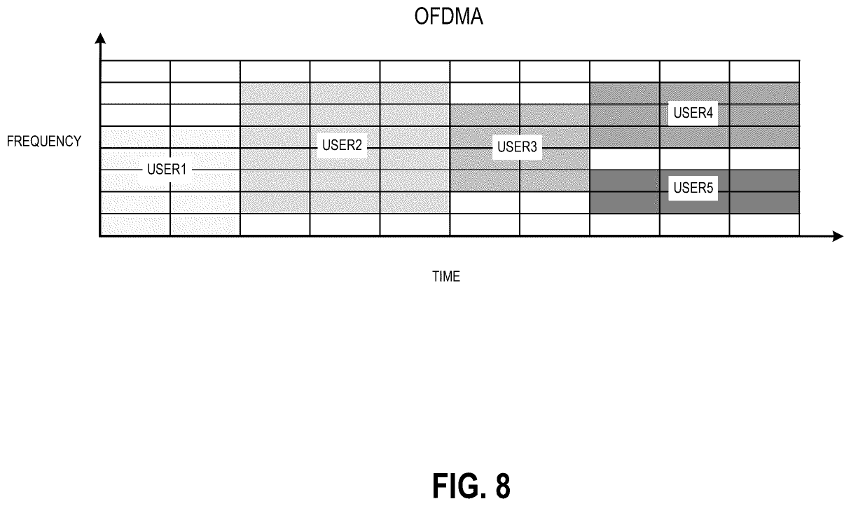

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

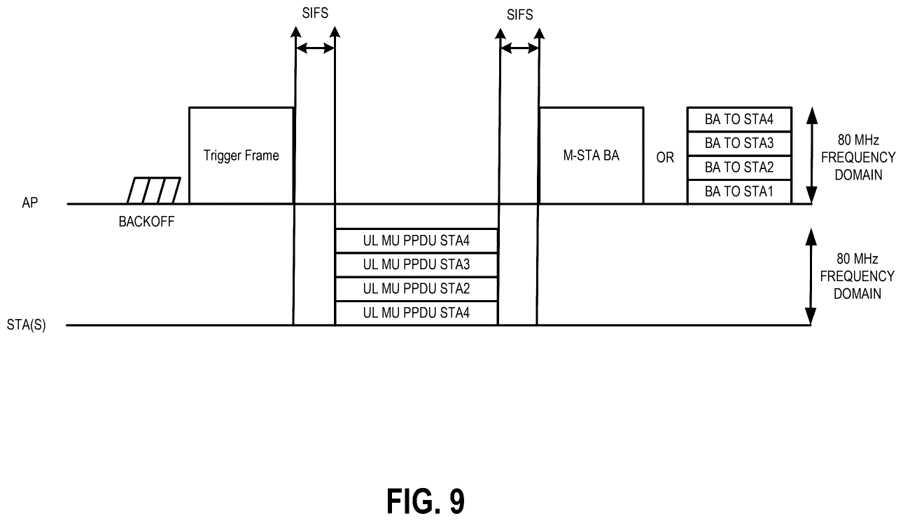

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:
Coordinated Beamforming (C-BF): Multiple APs transmit on the same frequency resource by coordinating and forming spatial nulls, allowing for simultaneous transmission from multiple APs.
Coordinated OFDMA (C-OFDMA): APs transmit on orthogonal frequency resources by coordinating and splitting the spectrum, enabling more efficient spectrum utilization.
Joint Transmission (JTX): Multiple APs transmit jointly to a given user simultaneously by sharing data between the APs.
Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

Multi-AP coordination schemes may help improve throughput in dense wireless network scenarios with many APs/BSSs. Some multi-AP coordination schemes such as coordinated beamforming (CoBF) and joint transmission require having channel state information for links between the APs (e.g., which may be beamformers) and STAs (e.g., which may be beamformees) such as compressed beamforming and channel quality information. In coordinated beamforming, each AP may need to obtain channel state information for the link between the AP and an in-BSS STA (a STA that is associated with the AP) and also channel state information for the link between the AP and an OBSS STA (a STA that is associated with a different AP). As used herein, the term channel state information may refer to information regarding channel characteristics and may include CB/CQI information (e.g., information that is typically included in CB/CQI frames of a IEEE 802.11 channel sounding procedure).

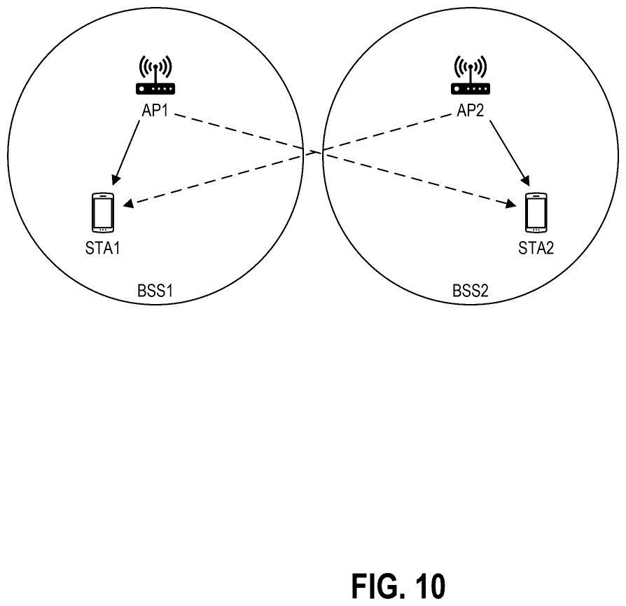

FIG. 10 is a diagram showing a wireless network in which coordinated beamforming can be performed, according to some embodiments.

As shown in the diagram, the wireless network includes a first AP (AP1) that operates a first BSS (BSS1) and a second AP (AP2) that operates a second BSS (BSS2). The wireless network may further include a first STA (STA1) that is associated with AP1 (and belongs to BSS1) and a second STA (STA2) that is associated with AP2 (and belongs to BSS2).

AP1 and AP2 may cooperate with each other to perform coordinated beamforming. The objective of coordinated beamforming is for each AP to transmit frames to an in-BSS STA without causing interference at OBSS STAs. That is, the objective is for AP1 to transmit frames to STA1 without causing interference at STA2 and for AP2 to transmit frames to STA2 without causing interference at STA1. The interference is represented in the diagram using dashed lines. To achieve this objective, AP1 needs to obtain channel state information (e.g., compressed beamforming and channel quality information) for the link between STA1 and AP1 and also needs to obtain channel state information for the link between STA2 and AP1. Similarly, AP2 needs to obtain channel state information for the link between STA2 and AP2 and also needs to obtain channel state information for the link between STA1 and AP2. The APs may perform an OBSS channel sounding procedure such as the first enhanced OBSS channel sounding procedure or the second enhanced OBSS channel sounding procedure described herein to obtain the channel state information.

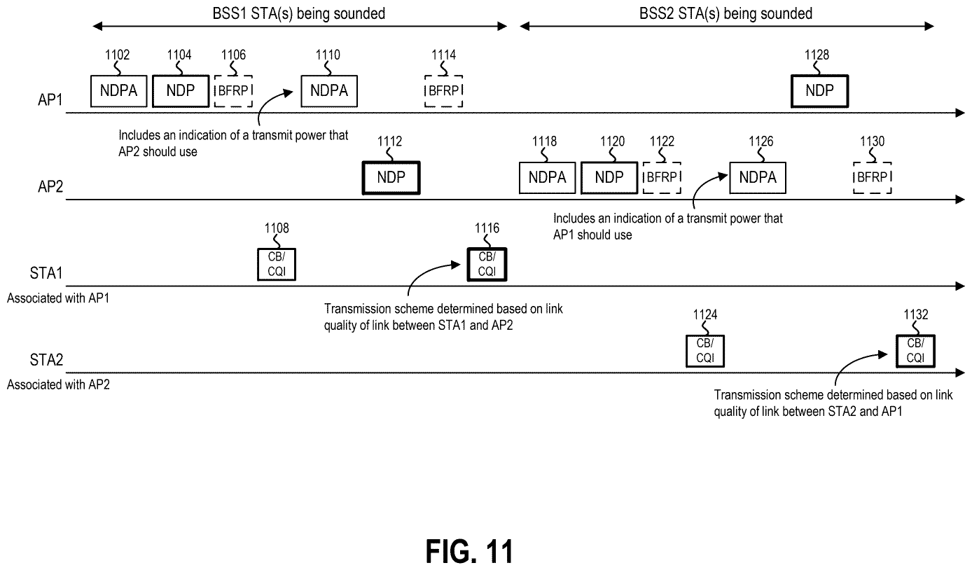

FIG. 11 is a diagram showing a first enhanced OBSS channel sounding procedure, according to some embodiments.

As shown in the diagram, the first enhanced OBSS channel sounding procedure may include a first phase for sounding BSS1 STA(s) and a second phase for sounding BSS2 STA(s). While the first enhanced OBSS channel sounding procedure shown in the diagram sounds BSS1 STA(s) before BSS2 STA(s), it should be appreciated that the sounding order can be switched. In an embodiment, the sounding order is predetermined/pre-negotiated during a multi-AP coordination setup process between AP1 and AP2.

As shown in the diagram, AP1 may transmit NDPA frame 1102 to initiate the first phase of the channel sounding procedure. AP1 may then transmit NDP frame 1104. STA1 may generate channel state information for the link between STA1 and AP1 based on NDP frame 1104. AP1 may then transmit beamforming report poll (BFRP) frame 1106 to cause STA1 to transmit CB/CQI frame 1108. A BFRP frame is an example of a trigger frame for soliciting channel state information. Responsive to receiving BFRP frame 1106, STA1 may transmit CB/CQI frame 1108. CB/CQI frame 1108 may include the previously generated channel state information for the link between STA1 and AP1. A CB/CQI frame is an example of a channel state information feedback frame that provides channel state information.

AP1 may then transmit NDPA frame 1110 to cause AP2 to transmit NDP frame 1112. In an embodiment, as shown in the diagram, NDPA frame 1110 may include an indication of a transmit power that AP2 should use (or will use) to transmit NDP frame 1112. In an embodiment, AP1 knows the transit power that AP2 will use to transmit NDP frame 1112 and includes an indication of this transmit power in NDPA frame 1110. Responsive to receiving NDPA frame 1110, AP2 may transmit NDP frame 1112 using the transmit power indicated in NDPA frame 1110. It is noted that AP1 transmits NDPA frame 1110 for the purpose of causing AP2 to transmit NDP frame 1112. Thus, AP1 does not transmit a NDP frame following the transmission of NDPA frame 1110. NDPA frame 1110 may include a request for AP2 to transmit NDP frame 1112. AP1 may then transmit BFRP frame 1114 to cause STA1 to transmit CB/CQI frame 1116. STA1 may generate channel state information for the link between STA1 and AP2 based on NDP frame 1112. Also, as shown in the diagram, STA1 may determine the transmission scheme to use for transmitting CB/CQI frame 1116 based on the link quality of the link between STA1 and AP2. In an embodiment, STA1 determines the link quality (e.g., signa-to-noise ratio (SNR)) of the link between STA1 and AP2 based on the transmit power used by AP2 to transmit NDP frame 1112 (as indicated in NDPA frame 1110) and the received signal quality of NDP frame 1112. In an embodiment, STA1 determines/derives the link quality of the link between STA1 and AP2 based on the channel state information for the link between STA1 and AP2. In an embodiment, link quality is quantified using a single/simple value (e.g., SNR), whereas the channel state information comprises multiple values (e.g., angles of channel coefficients and average SNR per space-time stream). Responsive to receiving BFRP frame 1114, STA1 may transmit CB/CQI frame 1116 using the determined transmission scheme. CB/CQI frame 1116 may include the previously generated channel state information for the link between STA1 and AP2. It is noted that the transmission of CB/CQI frame 1116 is triggered by AP1 (using BFRP frame 1114) but is intended for AP2.

Also, as shown in the diagram, AP2 may transmit NDPA frame 1118 to initiate the second phase of the channel sounding procedure. AP2 may then transmit NDP frame 1120. STA1 may generate channel state information for the link between STA2 and AP2 based on NDP frame 1120. AP2 may then transmit BFRP frame 1122 to cause STA2 to transmit CB/CQI frame 1124. Responsive to receiving BFRP frame 1122, STA2 may transmit CB/CQI frame 1124. CB/CQI frame 1124 may include the previously generated channel state information for the link between STA2 and AP2.

AP2 may then transmit NDPA frame 1126 to cause AP1 to transmit NDP frame 1128. In an embodiment, as shown in the diagram, NDPA frame 1126 may include an indication of a transmit power that AP1 should use (or will use) to transmit NDP frame 1128. In an embodiment, AP2 knows the transit power that AP1 will use to transmit NDP frame 1128 and includes an indication of this transmit power in NDPA frame 1126. Responsive to receiving NDPA frame 1126, AP1 may transmit NDP frame 1128 using the transmit power indicated in NDPA frame 1126. It is noted that AP2 transmits NDPA frame 1126 for the purpose of causing AP1 to transmit NDP frame 1128. Thus, AP2 does not transmit a NDP frame following the transmission of NDPA frame 1126. NDPA frame 1126 may include a request for AP1 to transmit NDP frame 1128. AP2 may then transmit BFRP frame 1130 to cause STA2 to transmit CB/CQI frame 1132. STA2 may generate channel state information for the link between STA2 and AP1 based on NDP frame 1128. Also, as shown in the diagram, STA2 may determine the transmission scheme to use for transmitting CB/CQI frame 1132 based on the link quality of the link between STA2 and AP1. In an embodiment, STA2 determines the link quality (e.g., SNR) of the link between STA2 and AP1 based on the transmit power used by AP1 to transmit NDP frame 1128 (as indicated in NDPA frame 1126) and the received signal quality of NDP frame 1128. In an embodiment, STA2 determines/derives the link quality of the link between STA2 and AP1 based on the channel state information for the link between STA2 and AP1. Responsive to receiving BFRP frame 1130, STA2 may transmit CB/CQI frame 1132 using the determined transmission scheme. CB/CQI frame 1132 may include the previously generated channel state information for the link between STA2 and AP1. It is noted that the transmission of CB/CQI frame 1132 is triggered by AP2 (using BFRP frame 1130) but is intended for AP1.

With the existing OBSS channel sounding procedure, STA1 would transmit CB/CQI frame 1116 using a transmission scheme that is selected based on the link quality of the link between STA1 and AP1. However, CB/CQI frame 1116 is intended for AP2 and the link quality of the link between STA1 and AP2 is typically poorer than the link quality of the link between STA1 and AP1. As a result, transmitting CB/CQI frame 1116 using a transmission scheme that is selected based on the link quality of the link between STA1 and AP1 may result in AP2 not being able to properly receive and decode CB/CQI frame 1116.

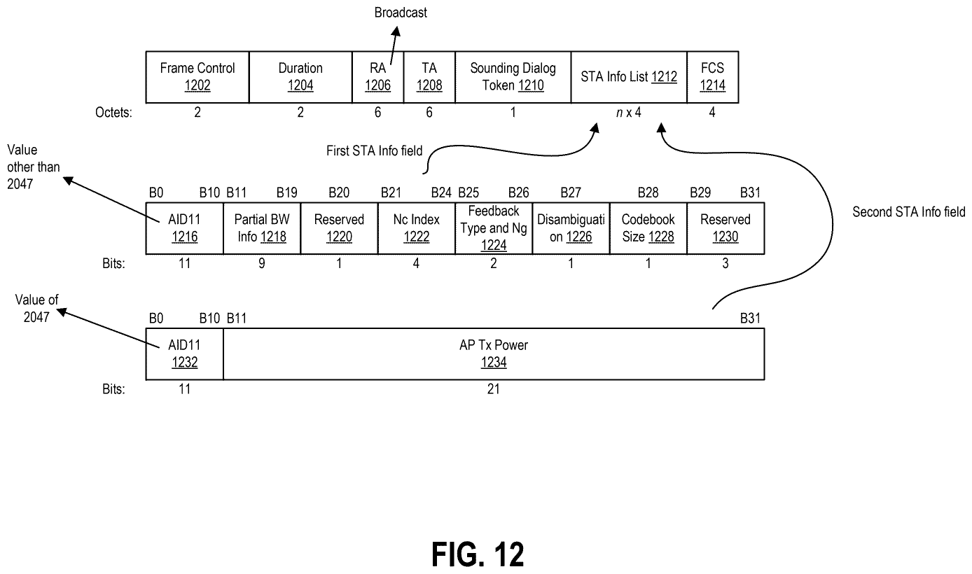

To address this problem, the first enhanced OBSS channel sounding procedure allows the STA providing the channel state information feedback to determine the transmission scheme to use for transmitting the channel state information feedback that is intended for an OBSS AP. The STA may determine the transmission scheme to use based on the link quality of the link between the STA and the OBSS AP. To help the STA determine the link quality of the link between the STA and the OBSS AP, the NDPA frame may be modified to include an indication of the transmit power that the OBSS AP should use (or will use) to transmit the NDP frame. For example, the existing NDPA frame format (e.g., as defined in IEEE 802.11 wireless networking standards) may be modified to include an “AP Tx Power” field or similar field that can be used for indicating the transmit power that the OBSS AP should use (or will use) to transmit the NDP frame. The existing NPDA frame format defined by IEEE 802.11 wireless networking standards does not include an AP Tx Power field. The STA may determine the link quality of the link between the STA and the OBSS AP based on the transmit power used by the OBSS AP to transmit the NDP frame (as indicated in the NDPA frame) and the received signal quality of the NDP frame. The STA may then determine the appropriate transmission scheme to use for transmitting a CB/CQI frame based on the link quality of the link between the STA and the OBSS AP. The TXOP of the STA can be guaranteed using a BFRP frame so that the STA has sufficient time to transmit the CB/CQI frame. An example NDPA frame format that includes an AP Tx Power field is shown in FIG. 12.

FIG. 12 is a diagram showing a NDPA frame format, according to some embodiments. While particular frame/field formats are shown in the diagrams to illustrate an embodiment, it should be appreciated that other frame/field formats can be used to accomplish the same/similar result. Thus, the frame/field formats shown in the diagram are provided by way of example and should not be considered limiting. For sake of brevity, only certain fields are highlighted and described in detail in the description. Unless indicated otherwise, the other fields can be understood as functioning as defined in the IEEE 802.11 wireless networking standards.

A first AP may transmit a NDPA frame having the NPDA frame format shown in the diagram to cause a second AP to transmit a NDP frame.

As shown in the diagram, the NPDA frame includes a frame control field 1202 (2 octets), a duration field 1204 (2 octets), a receiver address (RA) field 1206 (6 octets), a transmitter address (TA) field 1208, a sounding dialog token field 1210 (1 octet), a STA info list field 1212 (n×4 octets, where n is a positive integer), and a frame check sequence field 1214 (4 octets).

The STA info list field 1212 may include a first STA info field and a second STA info field. The first STA info field may include an AID11 field 1216 (11 bits), a partial bandwidth (BW) info field 1218 (9 bits), a reserved field 1220 (1 bit), a Nc index field 1222 (4 bits), a feedback type and Ng field 1224 (2 bits), a disambiguation field 1226 (1 bit), a codebook size field 1228 (1 bit), and a reserved field 1230 (3 bits).

The second STA info field may include an AID11 field 1232 (11 bits) and an AP Tx power field 1234 (21 bits). The bit positions of the fields may be as shown in the diagram.

In an embodiment, the RA field 1206 may include a broadcast address, the first STA info field may be addressed to the STA that is being sounded (e.g., the AID11 field 1216 included in the first STA info field may include the 11-bit AID of STA1 during the “BSS1 STA(s) being sounded” phase shown in FIG. 11), the second STA info field may include a special AID value that is reserved for OBSS NDPA (e.g., the AID11 field 1232 may include a value of 2047), and the AP Tx power field 1234 included in the second STA info field may include an indication of the transmit power that the OBSS AP should use (or will use) to transmit a NDP frame. Such an AID combination (e.g., one regular AID (e.g., not 2047) and one special AID (e.g., 2047)) can be regarded as an indication of triggering OBSS NDP frame transmission (an indication that the OBSS AP should transmit a NDP frame). As used herein, an OBSS NDPA frame (or simply OBSS NDPA) may refer to a NDPA frame that is transmitted for the purpose of causing an OBSS AP to transmit a NDP frame. In an embodiment, an OBSS AP that receives such an NDPA frame may set its transmit power to the transmit power indicated in the AP Tx power field 1234 before transmitting an NDP frame.

The NDPA frame format shown in the diagram includes a single STA info field that is addressed to a specific STA and a STA info field for triggering OBSS NDP frame transmission. In a MU-MIMO scenario, a NPDA frame can include multiple STA info fields addressed to multiple different STAs and an additional STA info field for triggering OBSS NDP frame transmission.

The NDPA frame format shown in FIG. 12 includes two STA info fields even though it is used for requesting channel state information feedback from a single STA. In an embodiment, to further simplify the NDPA frame, information included in a previously transmitted NPDA frame can be reused. The “Partial BW Info” fields included in the first and second NDPA frames during the same phase (e.g., NDPA frame 1102 and NDPA frame 1110 transmitted during the “BSS1 STA(s) being sounded” phase shown in FIG. 11) should include the same value because the indicated channels are used for multi-AP coordination at the same time (e.g., in multi-AP coordination, two APs can act as a single virtual AP and thus they operate in the same bandwidth). If the STA that receives a NDPA frame recognizes that the NDPA frame is the second NDPA frame transmitted during a particular phase, the STA can use the value included in the Partial BW Info field included in the first/previous NDPA frame for channel sounding purposes. This means that the Partial BW Info field can be omitted from the second NDPA frame to save bits in the STA info field. Accordingly, in an embodiment, the second NDPA frame may include a new STA info field that omits the Partial BW Info field and repurposes the bits that were saved by omitting the Partial BW Info field to indicate AP transmit power.

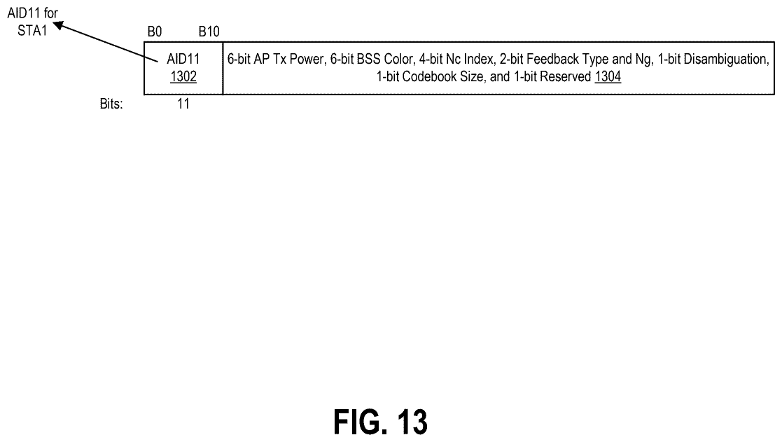

FIG. 13 is a diagram showing a STA info field format, according to some embodiments. A STA info field having the STA info field format may be included in an NDPA frame to trigger OBSS NDP frame transmission.

As shown in the diagram, the STA info field includes an AID11 field 1302 (11 bits) and additional fields 1304 including a 6-bit AP Tx power field, a 6-bit BSS color field, a 4-bit Nc index field, a 2-bit feedback type and Ng field, a 1-bit disambiguation field, a 1-bit codebook size field, and a 1-bit reserved field.

The AID 11 field 1302 may include the 11-bit AID of the STA being sounded. The AP Tx power field may include an indication of the transmit power that the OBSS AP should use to transmit a NDP frame. The BSS color field may include an indication of the BSS color of the BSS operated by the OBSS AP (or otherwise indicate the OBSS AP that is to transmit a NDP frame). The OBSS AP may interpret this STA info field (e.g., to obtain the AP transmit power) even though it is addressed to a STA.

A STA that receives the NDPA frame described herein (which includes an indication of the AP transmit power) may estimate the SNR difference between the in-BSS link (the link between the STA and its associated AP) and the OBSS link (the link between the STA and a non-associated AP). For example, in the example shown in FIG. 11, STA1 may estimate the link quality of the link between STA1 and AP1 (an in-BSS link) based on the AP transmit power indicated in BFRP frame 1106 and the received signal quality of BFRP frame 1106. Also, STA1 may estimate the link quality of the link between STA1 and AP2 (an OBSS link) based on the AP transmit power indicated in NDPA frame 1110 and the received signal quality of NDP frame 1112 (transmitted by AP2). The STA may then determine the signal quality difference between the in-BSS link and the OBSS link and determine the appropriate transmission scheme to use for transmitting a channel state information feedback frame based on the difference. For example, STA1 may determine that the SNR of the link between STA1 and AP1 is 30 decibels (dB) and that the SNR of the link between STA1 and AP2 is 10 dB, and thus that the difference in link quality is 20 dB. If MCS 6 (64-QAM, ¾ code rate) is used in the link between STA1 and AP1, STA1 may decide to use MCS 1 (QPSK, ½ code rate) in the link between STA1 and AP2 (to allow AP2 to better receive and decode the frame).

In existing wireless network standards, the STA being triggered by a trigger frame should use the transmission scheme (e.g., MCS, the number of spatial streams, bandwidth, etc.) indicated/suggested by the trigger frame or the most robust transmission scheme (e.g., lowest MCS). For example, in existing wireless networking standards, STA1 (which is triggered by BFRP frame 1114) should use the transmission scheme indicated/suggested by BFRP frame 1114 when transmitting CB/CQI frame 1116. With embodiments disclosed herein, however, the triggered STA is not required to use the transmission scheme indicated/suggested by the trigger frame or the most robust transmission scheme to transmit a CB/CQI frame, but the STA can determine the transmission scheme to use based on the signal quality of the OBSS link. For example, STA1 may determine the transmission scheme to use for transmitting CB/CQI frame 1116 based on the link quality of the link between STA1 and AP2. This allows the triggered STA to transmit the CB/CQI frame using an appropriate transmission scheme that allows for proper reception/decoding at AP2 without unnecessarily reducing the data rate.

In existing channel sounding procedures, the STA/beamformee uses the same partial bandwidth information indicated by the AP/beamformer in the NDPA frame (e.g., indicated in the “Partial BW Info” field included in the NDPA frame). For example, STA1 would use the partial bandwidth information indicated in NDPA frame 1110 when transmitting CB/CQI frame 1116. That is, the partial bandwidth information indicated by the NDPA frame and the corresponding CB/CQI frame are identical. The partial bandwidth information is determined by the AP that transmits the NDPA frame, without having any knowledge of the OBSS link quality or capabilities. This means that the AP transmitting the NDPA frame determines the partial bandwidth information for the OBSS AP. However, the OBSS AP might not support the requested subchannels/RUs/bandwidth or the requested subchannels/RUs may have high interference in the link between the STA and the OBSS AP. This means that some subchannels/RUs might not have sufficiently high channel quality to be used for CoBF transmission or channel state information feedback.

In an embodiment, the STA being sounded provides channel state information feedback for a subset of the subchannels/RUs indicated by the partial bandwidth information indicated in the NDPA frame (e.g., indicated in the Partial BW info field included in the NPDA frame) depending on channel and interference conditions. For example, STA1 may provide channel state information feedback for just a subset of the subchannels/RUs (resource units) indicated by the partial bandwidth information indicated in NDPA frame 1110 when transmitting CB/CQI frame 1116 (e.g., CB/CQI frame 1116 may omit channel state information for certain subcarriers/RUs if AP2 does not support them or they have poor channel quality). Thus, CB/CQI frame 1116 may be allowed to include a Partial BW info field that includes an indication of a partial bandwidth that is different from the partial bandwidth indicated in NDPA frame 1110.

In existing OBSS channel sounding procedures, the AP that transmits the NDPA frames and BFRP frames may not know the link quality of OBSS links. Thus, it might not be appropriate for the AP to determine the transmission scheme and partial bandwidth information that a STA should use for transmitting channel state information feedback frames (e.g., CB/CQI frames) intended for an OBSS AP. The first enhanced OBSS channel sounding procedure described herein allows the STA (e.g., beamformee) to determine the transmission scheme and/or partial bandwidth info to use when transmitting channel state information feedback frames intended for an OBSS AP. This can help reduce the packet error probability of channel state information feedback frames without unnecessarily degrading performance and may allow proper selection of the operating bandwidth for multi-AP coordination. For example, the enhanced OBSS channel sounding procedure described herein may 1) minimize decoding error of CB/CQI frames at OBSS APs; and 2) minimize the transmission time of CB/CQI frame by using the highest/appropriate MCS supported by a given OBSS channel quality. Also, as another example, the enhanced OBSS channel sounding procedure described herein may allow an AP to determine when an OBSS link has poor channel quality in certain partial bandwidth. The AP may exclude the partial bandwidth when performing multi-AP coordination since the inclusion of such partial bandwidth can degrade overall performance of the multi-AP coordination. For multiple cooperating APs, the operating bandwidth agreement may be required. While it is possible to estimate the OBSS link quality and achieve operating bandwidth agreement using additional frame exchange, this can be regarded as a waste of resources compared to the approach described herein which does not require an additional frame exchange.

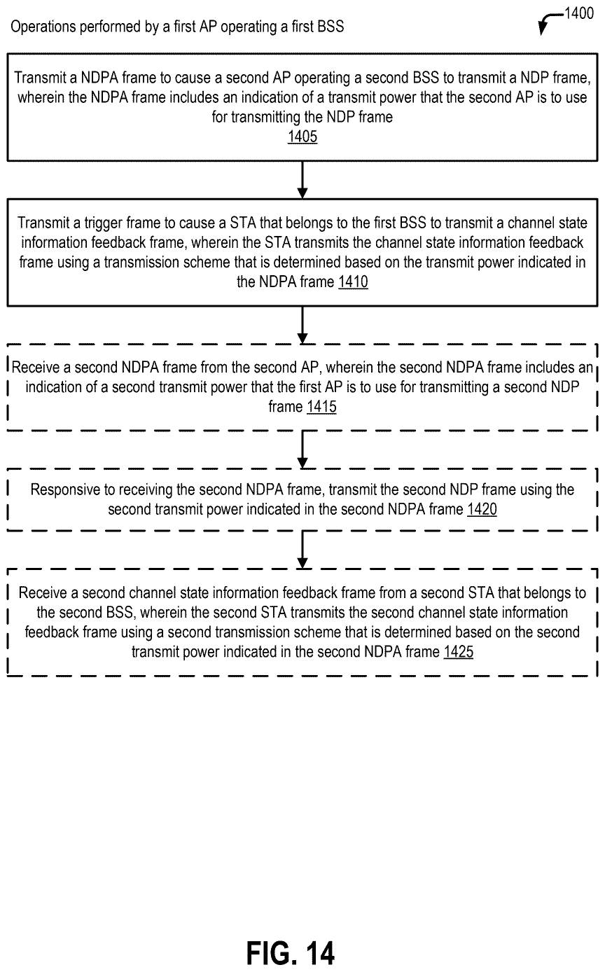

Turning now to FIG. 14, a method 1400 will be described for performing an OBSS channel sounding procedure, in accordance with an example embodiment. The method 1400 may be performed by a first AP operating a first BSS (e.g., AP1 in the first phase (BSS1 STA(s) being sounded phase) shown in FIG. 11). The first AP may be implemented by a wireless device (e.g., wireless device 104).

Additionally, although shown in a particular order, in some embodiments the operations of the method 1400 (and the other methods shown in the other figures) may be performed in a different order. For example, although the operations of the method 1400 are shown in a sequential order, some of the operations may be performed in partially or entirely overlapping time periods.

At operation 1405, the first AP transmits a NDPA frame to cause a second AP operating a second BSS to transmit a NDP frame, wherein the NDPA frame includes an indication of a transmit power that the second AP is to use for transmitting the NDP frame. In an embodiment, the NDPA frame includes a first STA information field and a second STA information field, wherein the first STA information field is addressed to the STA and the second STA information field includes the indication of the transmit power. In an embodiment, the second STA information field includes an AID field (e.g., AID11 field) that includes a value that is reserved for OBSS NDPA (e.g., a value of 2047) and a transmit power field that includes the indication of the transmit power. In an embodiment, the NDPA frame includes a STA information field addressed to the STA, wherein the STA information field includes a transmit power field that includes the indication of the transmit power. In an embodiment, the STA information field further includes a BSS color field that includes an indication of a BSS color of the second BSS.

At operation 1410, the first AP transmits a trigger frame to cause a STA that belongs to the first BSS to transmit a channel state information feedback frame, wherein the STA transmits the channel state information feedback frame using a transmission scheme that is determined based on the transmit power indicated in the NDPA frame. In an embodiment, the transmission scheme comprises one or more of: a MCS, a number of spatial streams, and a cyclic prefix length. In an embodiment, the channel state information feedback frame includes a partial bandwidth field (e.g., Partial BW info field) that includes an indication of a partial bandwidth that is different from a partial bandwidth indicated in the NDPA frame.

In an embodiment, the trigger frame is a BFRP frame and the channel state information feedback frame is a CB/CQI frame.

In an embodiment, at operation 1415, the first AP receives a second NDPA frame from the second AP, wherein the second NDPA frame includes an indication of a second transmit power that the first AP is to use for transmitting a second NDP frame.

In an embodiment, at operation 1420, responsive to receiving the second NDPA frame, the first AP transmits the second NDP frame using the second transmit power indicated in the second NDPA frame.

In an embodiment, at operation 1425, the first AP receives a second channel state information feedback frame from a second STA that belongs to the second BSS, wherein the second STA transmits the second channel state information feedback frame using a second transmission scheme that is determined based on the second transmit power indicated in the second NDPA frame.

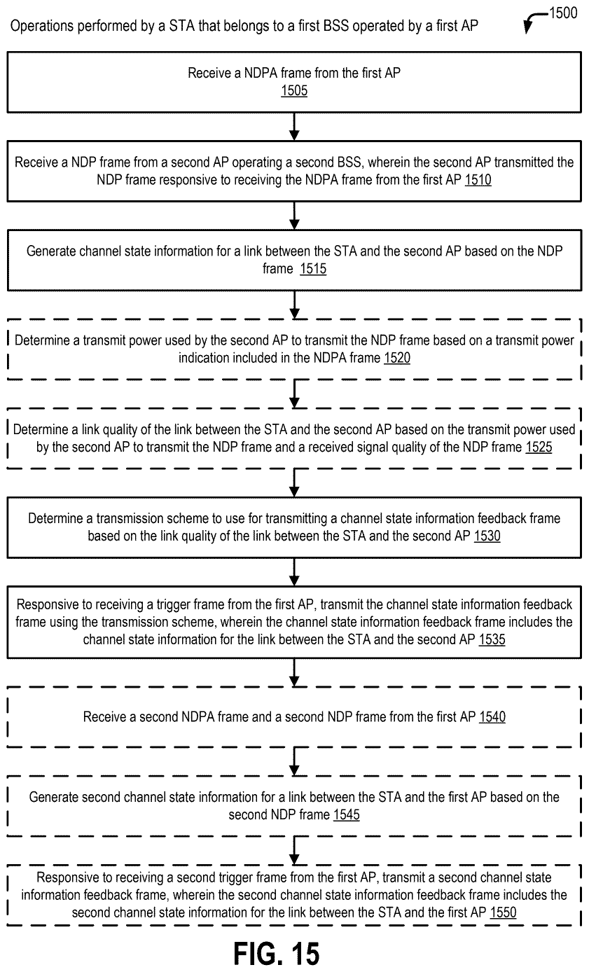

Turning now to FIG. 15, a method 1500 will be described for performing an OBSS channel sounding procedure, in accordance with an example embodiment. The method 1500 may be performed by a STA (e.g., STA1 in the first phase (BSS1 STA(s) being sounded phase) shown in FIG. 11) that belongs to a first BSS operated by a first AP. The STA may be implemented by a wireless device (e.g., wireless device 104).

At operation 1505, the STA receives a NDPA frame from the first AP.

At operation 1510, the STA receives a NDP frame from a second AP operating a second BSS, wherein the second AP transmitted the NDP frame responsive to receiving the NDPA frame from the first AP.

At operation 1515, the STA generates channel state information for a link between the STA and the second AP based on the NDP frame.

In an embodiment, at operation 1520, the STA determines a transmit power used by the second AP to transmit the NDP frame based on a transmit power indication included in the NDPA frame. In an embodiment, the NDPA frame includes a first STA information field and a second STA information field, wherein the first STA information field is addressed to the STA and the second STA information field includes the transmit power indication. In an embodiment, the NDPA frame includes a STA information field addressed to the STA, wherein the STA information field includes a transmit power field that includes the transmit power indication.

In an embodiment, at operation 1525, the STA determines a link quality of the link between the STA and the second AP based on the transmit power used by the second AP to transmit the NDP frame and a received signal quality of the NDP frame.

At operation 1530, the STA determines a transmission scheme to use for transmitting a channel state information feedback frame based on the link quality of the link between the STA and the second AP. In an embodiment, the transmission scheme comprises one or more of: a MCS, a number of spatial streams, and a cyclic prefix length. In an embodiment, the link quality of the link between the STA and the second AP is quantified using SNR. In an embodiment, the link quality of the link between the STA and the second AP is derived from the channel state information for the link between the STA and the second AP. In an embodiment, the transmission scheme is determined based on a difference in link quality of the link between the STA and the second AP and a link between the STA and the first AP. In an embodiment, the link quality of the link between the STA and the first AP is determined based on a transmit power used by the first AP to transmit the trigger frame and a received signal quality of the trigger frame.

At operation 1535, responsive to receiving a trigger frame from the first AP, the STA transmits the channel state information feedback frame using the transmission scheme, wherein the channel state information feedback frame includes the channel state information for the link between the STA and the second AP. In an embodiment, the channel state information feedback frame includes a partial bandwidth field that includes an indication of a partial bandwidth that is different from a partial bandwidth indicated in the NDPA frame.

In an embodiment, the trigger frame is a BFRP frame and the channel state information feedback frame is a CB/CQI frame.

In an embodiment, at operation 1540, the STA receives a second NDPA frame and a second NDP frame from the first AP.

In an embodiment, at operation 1545, the STA generates second channel state information for a link between the STA and the first AP based on the second NDP frame.

In an embodiment, at operation 1550, responsive to receiving a second trigger frame from the first AP, the STA transmits a second channel state information feedback frame, wherein the second channel state information feedback frame includes the second channel state information for the link between the STA and the first AP.

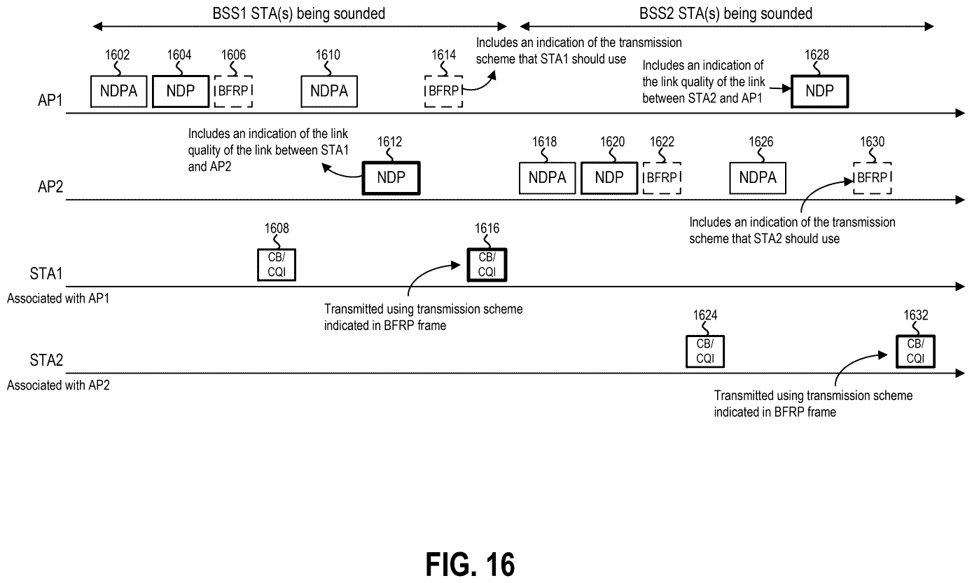

FIG. 16 is a diagram showing a second enhanced OBSS channel sounding procedure, according to some embodiments.

As shown in the diagram, the second enhanced OBSS channel sounding procedure may include a first phase for sounding BSS1 STA(s) and a second phase for sounding BSS2 STA(s). While the second enhanced OBSS channel sounding procedure shown in the diagram sounds BSS1 STA(s) before BSS2 STA(s), it should be appreciated that the sounding order can be switched. In an embodiment, the sounding order is predetermined/pre-negotiated during a multi-AP coordination setup process between AP1 and AP2.

As shown in the diagram, AP1 may transmit NDPA frame 1602 to initiate the first phase of the channel sounding procedure. AP1 may then transmit NDP frame 1604. STA1 may generate channel state information for the link between STA1 and AP1 based on NDP frame 1604. AP1 may then transmit BFRP frame 1606 to cause STA1 to transmit CB/CQI frame 1608. A BFRP frame is an example of a trigger frame for soliciting channel state information. Responsive to receiving BFRP frame 1606, STA1 may transmit CB/CQI frame 1608. CB/CQI frame 1608 may include the previously generated channel state information for the link between STA1 and AP1. A CB/CQI frame is an example of a channel state information feedback frame that provides channel state information.

AP1 may then transmit NDPA frame 1610 to cause AP2 to transmit NDP frame 1612. Responsive to receiving NDPA frame 1610, AP2 may transmit NDP frame 1612. It is noted that AP1 transmits NDPA frame 1610 for the purpose of causing AP2 to transmit NDP frame 1612. Thus, AP1 does not transmit a NDP frame following the transmission of NDPA frame 1610. NDPA frame 1610 may include a request for AP2 to transmit NDP frame 1612. In an embodiment, AP2 estimates the link quality of the link between STA1 and AP2 based on CB/CQI frame 1608 and includes an indication of the link quality of the link between STA1 and AP2 in NDP frame 1612. In an embodiment, link quality is quantified using a single/simple value (e.g., SNR), whereas the channel state information comprises multiple values (e.g., angles of channel coefficients and average SNR per space-time stream). In an embodiment, AP2 includes, in NDP frame 1612, an indication of the recommended transmission scheme that STA1 should use to transmit a frame (in lieu of the link quality). The recommended transmission scheme may be determined based on the link quality of the link between STA1 and AP2. STA1 may generate channel state information for the link between STA1 and AP2 based on NDP frame 1612.

AP1 may then transmit BFRP frame 1614 to cause STA1 to transmit CB/CQI frame 1616. AP1 may determine a transmission scheme that STA1 is to use for transmitting CB/CQI frame 1616 (e.g., a modulation coding scheme (MCS) and a number of spatial streams to use) based on the link quality of the link between STA1 and AP2 indicated in NDP frame 1612 (or the recommended transmission scheme indicated in NDP frame 1612) and include an indication of this transmission scheme in BFRP frame 1614. Responsive to receiving BFRP frame 1614, STA1 may transmit CB/CQI frame 1616 using the transmission scheme indicated in BFRP frame 1614. CB/CQI frame 1616 may include the previously generated channel state information for the link between STA1 and AP2. It is noted that the transmission of CB/CQI frame 1616 is triggered by AP1 (using BFRP frame 1614) but is intended for AP2.

Also, as shown in the diagram, AP2 may transmit NDPA frame 1618 to initiate the second phase of the channel sounding procedure. AP2 may then transmit NDP frame 1620. STA1 may generate channel state information for the link between STA2 and AP2 based on NDP frame 1620. AP2 may then transmit BFRP frame 1622 to cause STA2 to transmit CB/CQI frame 1624. Responsive to receiving BFRP frame 1622, STA2 may transmit CB/CQI frame 1624. CB/CQI frame 1624 may include the previously generated channel state information for the link between STA2 and AP2.

AP2 may then transmit NDPA frame 1626 to cause AP1 to transmit NDP frame 1628. Responsive to receiving NDPA frame 1626, AP1 may transmit NDP frame 1628. It is noted that AP2 transmits NDPA frame 1626 for the purpose of causing AP1 to transmit NDP frame 1628. Thus, AP2 does not transmit a NDP frame following the transmission of NDPA frame 1626. NDPA frame 1626 may include a request for AP2 to transmit NDP frame 1628. In an embodiment, AP1 estimates the link quality of the link between STA2 and AP1 based on CB/CQI frame 1624 and includes an indication of the link quality of the link between STA2 and AP1 in NDP frame 1628. In an embodiment, AP1 includes, in NDP frame 1628, an indication of the recommended transmission scheme that STA2 should use to transmit a frame (in lieu of the link quality). The recommended transmission scheme may be determined based on the link quality of the link between STA2 and AP1. STA2 may generate channel state information for the link between STA2 and AP1 based on NDP frame 1628.

AP2 may then transmit BFRP frame 1630 to cause STA2 to transmit CB/CQI frame 1632. AP2 may determine a transmission scheme that STA2 is to use for transmitting CB/CQI frame 1632 (e.g., a MCS and a number of spatial streams to use) based on the link quality of the link between STA2 and AP1 indicated in NDP frame 1628 (or the recommended transmission scheme indicated in NDP frame 1628) and include an indication of this transmission scheme in BFRP frame 1630. Responsive to receiving BFRP frame 1630, STA2 may transmit CB/CQI frame 1632 using the transmission scheme indicated in BFRP frame 1630. CB/CQI frame 1632 may include the previously generated channel state information for the link between STA2 and AP1. It is noted that the transmission of CB/CQI frame 1632 is triggered by AP2 (using BFRP frame 1630) but is intended for AP1.

With the existing OBSS channel sounding procedure, STA1 would transmit CB/CQI frame 1616 using a transmission scheme that is selected based on the link quality of the link between STA1 and AP1. However, CB/CQI frame 1616 is intended for AP2 and the link quality of the link between STA1 and AP2 is typically poorer than the link quality of the link between STA1 and AP1. As a result, transmitting CB/CQI frame 1616 using a transmission scheme that is selected based on the link quality of the link between STA1 and AP1 may result in AP2 not being able to properly receive and decode CB/CQI frame 1616.

To address this problem, the second enhanced OBSS channel sounding procedure allows the OBSS AP (e.g., AP2 in the first phase) to include an indication of the link quality of the link between the in-BSS STA (STA1 in the first phase) and the OBSS AP in the NDP frame that the OBSS AP transmits. The OBSS AP may determine the link quality of the link between the in-BSS STA and the OBSS AP based on a CB/CQI frame previously transmitted by the in-BSS STA to the in-BSS AP (e.g., AP1 in the first phase). The in-BSS AP (e.g., AP1 in the first phase) may determine the transmission scheme (e.g., MCS and number of spatial streams) that the in-BSS STA should use to transmit a CB/CQI frame based on the link quality of the link between the in-BSS STA and the OBSS AP indicated in the NDP frame. The in-BSS AP may then transmit a BFRP frame to cause the in-BSS STA to transmit the CB/CQI frame, where this BFRP frame includes an indication of the determined transmission scheme. Responsive to receiving the BFRP frame, the in-BSS STA may transmit the CB/CQI frame using the transmission scheme indicated in the BFRP frame.

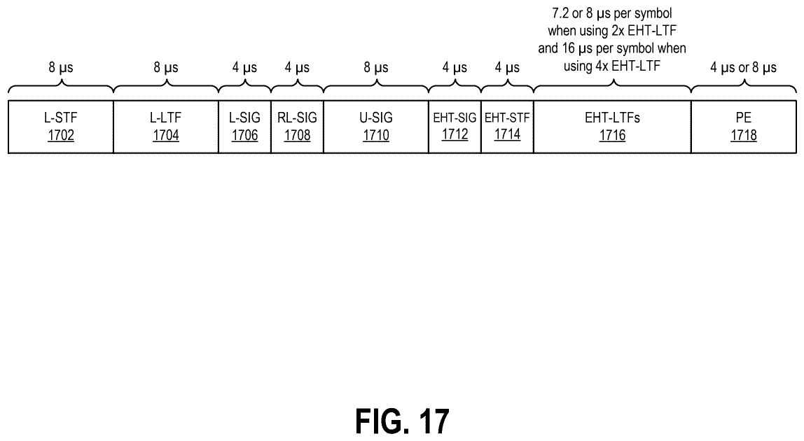

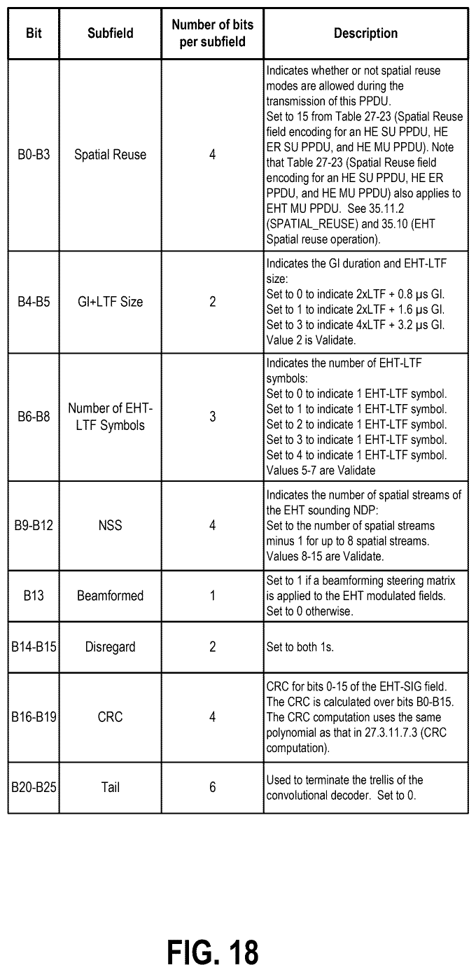

The existing NDP frame format (e.g., NDP frame format defined in IEEE 802.11 wireless networking standards) may be modified to include an indication of the link quality of an OBSS link (e.g., the link between the AP transmitting the NDP frame and a STA belonging to a different BSS from the BSS operated by the AP transmitting the NDP frame) or an indication of a transmission scheme. For example, the common field of an NDP frame may be modified to include such indication. An example NDP frame format is shown in FIG. 17 and an example field format for a common field of a NDP frame is shown in FIG. 18.

FIG. 17 is a diagram showing a NDP frame format, according to some embodiments. This is an example frame format for an EHT sounding NDP frame.

As shown in the diagram, the NDP frame may include a L-STF field 1702 (8 μs), a L-LTF field 1704 (8 μs), a L-SIG field 1706 (4 μs), a RL-SIG field 1708 (4 μs), a U-SIG field 1710 (8 μs), an EHT-SIG field 1712 (4 μs), an EHT-STF field 1714 (4 μs), an EHT-LTFs field 1716 (7.2 or 8 μs per symbol when using 2× EHT-LTF and 16 μs per symbol when using 4× EHT-LTF), and a PE field 1718 (4 μs or 8 μs).

FIG. 18 is a diagram showing a field format for a common field of a NDP frame, according to some embodiments. The common field may be included in the EHT-SIG field of the NDP frame.

As shown in the diagram, the common field may include a spatial reuse field (bits B0-B3), a GI+LTF size field (bits B4-B5), a number of EHT-LTF symbols field (bits B6-B8), a NSS field (bits B9-B12), a beamformed field (bit B13), a disregard field (bits B14-B15), a CRC field (bits B16-B19), and a tail field (bits B20-B25).

In FIG. 16, NDP frame 1604 and NDP frame 1620 may be considered as in-BSS NDP frames (since they are used for sounding in-BSS links with respect to the transmitting AP (e.g., the link between STA1 and AP1)) and NDP frame 1612 and NDP frame 1628 may be considered as OBSS NDP frames (since they are used for sounding OBSS links with respect to the transmitting AP (e.g., the link between STA1 and AP2)). An in-BSS NDP frame may have a traditional NDP frame format (e.g., the NDP frame format currently defined in existing IEEE 802.11 wireless networking standards). An OBSS NDP frame may have a frame format that is similar to an in-BSS NDP frame but modified to indicate additional information (e.g., link quality or transmission scheme information), as will be described in additional detail herein.

In an EHT sounding NDP frame, the EHT-SIG field 1712 may include both a “number of EHT-LTF symbols” field and a “NSS” field. In the IEEE 802.11be wireless networking standard, the required number of EHT-LTF symbols is determined by the value included in the “NSS” field. However, the “number of EHT-LTF symbols” field can be used to increase the number of EHT-LTF symbols to enhance channel estimation accuracy. Thus, the “number of EHT-LTF symbols” field can be regarded as an optional (non-mandatory) field. In an embodiment, the “number of EHT-LTF symbols” field and the “disregard” field can be omitted from the NDP frame and the bits saved from omitting these fields can be used for carrying OBSS link quality information or transmission scheme information. For example, five bits in the NDP frame can be saved by omitting these fields (e.g., three bits for the “number of EHT-LTF symbols” field and two bits for the disregard field) and these five bits may carry OBSS link quality information or transmission scheme information. The link quality information may be the SNR of an OBSS link (e.g., the link between STA1 and AP2 in the first phase) or the SNR difference between the in-BSS link (e.g., the link between STA1 and AP1) and the OBSS link (e.g., the link between STA1 and AP2). The transmission scheme information may include the recommended MCS and/or NSS. Only certain combinations of MCS and NSS may be encoded due to the limited number of bits available (e.g., five bits) for this purpose.

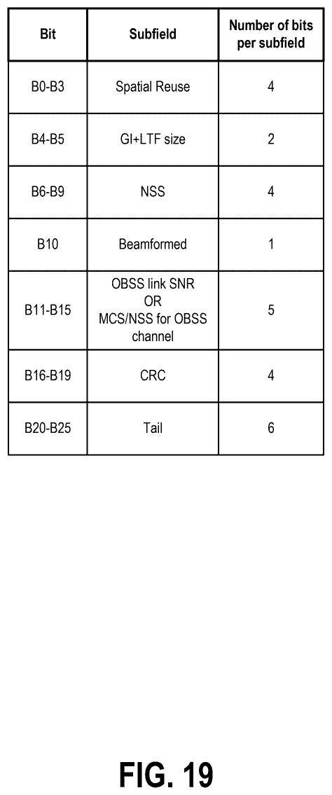

FIG. 19 is a diagram showing a format of a common field of an OBSS NDP frame that includes five bits for carrying OBSS link quality information or transmission scheme information, according to some embodiments.

As shown in the diagram, the common field may include a spatial reuse field (bits B0-B3), a GI+LTF size field (bits B4-B5), a NSS field (bits B6-B9), a beamformed field (bit B10), an OBSS link SNR field or MCS/NSS field (bits B11-B15), a CRC field (bits B16-B19), and a tail field (bits B20-B25). Notably, this common field does not include a number of EHT-LTF symbols field and a disregard field, but instead includes a five-bit OBSS link SNR field for carrying OBSS link SNR (link quality) information or a five-bit MCS/NSS field for carrying recommended MCS/NSS (transmission scheme) information.

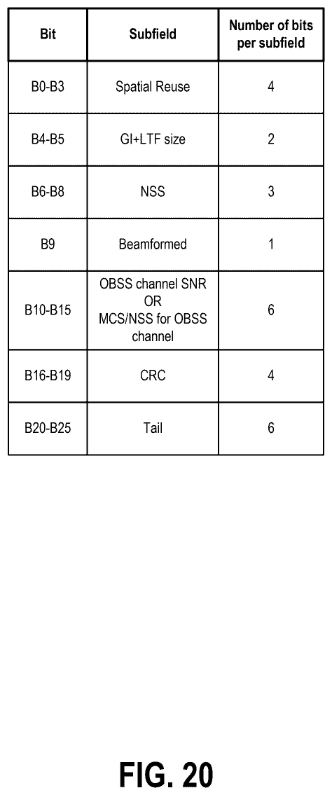

If the number of spatial streams indicated in the OBSS NDP frame is less than or equal to eight (8), only three bits are needed for the NSS field (instead of four bits) and the one bit that is saved can also be used for carrying OBSS link SNR information or MCS/NSS information, as shown in FIG. 20.

FIG. 20 is a diagram showing a format of a common field of an OBSS NDP frame that includes six bits for carrying OBSS link quality information or transmission scheme information, according to some embodiments.

As shown in the diagram, the common field may include a spatial reuse field (bits B0-B3), a GI+LTF size field (bits B4-B5), a NSS field (bits B6-B8), a beamformed field (bit B9), an OBSS link SNR field or MCS/NSS field (bits B10-B15), a CRC field (bits B16-B19), and a tail field (bits B20-B25). Notably, this common field does not include a number of EHT-LTF symbols field and a disregard field, and the NCS field includes three bits (instead of the customary four bits). Also, this common info field includes a six-bit OBSS link SNR field for carrying OBSS link SNR (link quality) information or a six-bit MCS/NSS field for carrying recommended MCS/NSS (transmission scheme) information.

If the “number of EHT-LTF symbols” field cannot be omitted, a new NDP frame can be defined to carry OBSS link SNR information or recommended MCS/NSS information. In an embodiment, an OBSS NDP frame may include a common field that includes a bit/field for indicating whether a user-specific field follows the common field. If this bit/field indicates that a user-specific field follows the common field, then the OBSS NDP frame may also include a user-specific field that follows the common field. Otherwise, if the bit/field indicates that a user-specific field does not follow the common field, then the OBSS NDP frame does not include a user-specific field that follows the common field. If a user-specific field is present, it may carry OBSS link SNR information or recommended MCS/NSS information (e.g., the recommended MCS and NSS to use for transmitting a CB/CQI frame (e.g., which can be indicated in a BFRP frame that triggers the CB/CQI frame)).

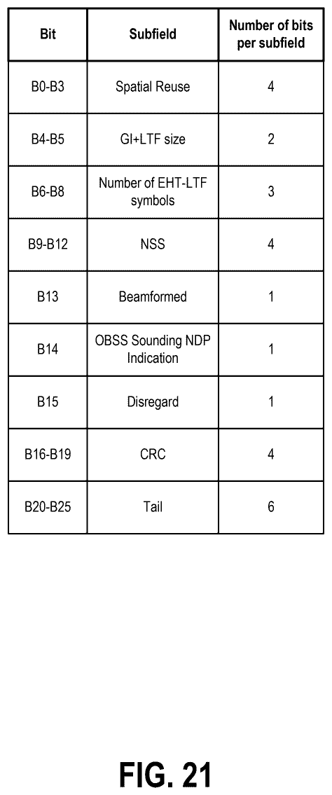

FIG. 21 is a diagram showing a format of a common field of an OBSS NDP frame that includes a bit for indicating that a user-specific field follows the common field, according to some embodiments.

As shown in the diagram, the common field may include a spatial reuse field (bits B0-B3), a GI+LTF size field (bits B4-B5), a number of EHT-LTF symbols field (bits B6-B8), a NSS field (bits B9-B12), a beamformed field (bit B13), an OBSS sounding NDP indication field (bit B14), a disregard field (bit B15), a CRC field (bits B16-B19), and a tail field (bits B20-B25).

Notably, the common field includes a disregard field that includes a single bit (instead of the customary two bits) and includes an OBSS sounding NDP indication field for indicating whether a user-specific field follows the common field (one of the two disregard bits may be repurposed to indicate whether a user-specific field is present). If a user-specific field follows the common field, the user-specific field may carry OBSS link SNR information or recommended MCS/NSS information.

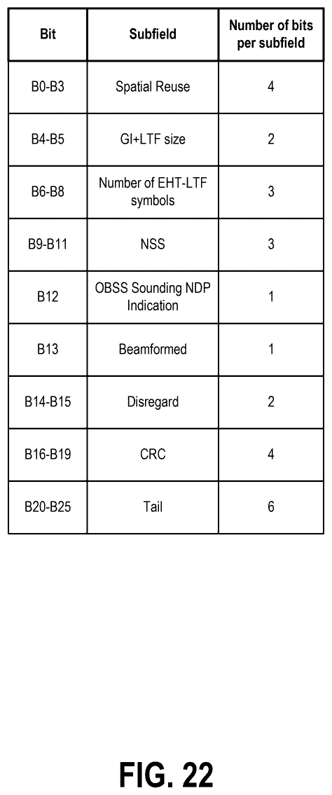

FIG. 22 is a diagram showing a format of a common field of an OBSS NDP frame that includes a bit for indicating that a user-specific field follows the common field, according to some embodiments.

As shown in the diagram, the common field may include a spatial reuse field (bits B0-B3), a GI+LTF size field (bits B4-B5), a number of EHT-LTF symbols field (bits B6-B8), a NSS field (bits B9-B11), an OBSS sounding NDP indication field (bit B12), a beamformed field (bit B13), a disregard field (bits B14-B15), a CRC field (bits B16-B19), and a tail field (bits B20-B25).

Notably, the common field includes a NSS field that includes three bits (instead of the customary four bits) and includes an OBSS sounding NDP indication field for indicating whether a user-specific field follows the common field (one of the three NSS bits may be repurposed to indicate whether a user-specific field is present). If a user-specific field follows the common field, the user-specific field may carry OBSS link SNR information or recommended MCS/NSS information.

The second enhanced OBSS channel sounding procedure may allow an OBSS AP to include information (e.g., OBSS link quality information or recommended transmission scheme information) in an NDP frame that it transmits to allow the in-BSS AP (the AP initiating the OBSS sounding procedure) to determine the appropriate transmission scheme that an in-BSS STA should use to transmit a CB/CQI frame that is intended for the OBSS AP. This may help increase the probability that the OBSS AP can properly receive and decode the CB/CQI frame.

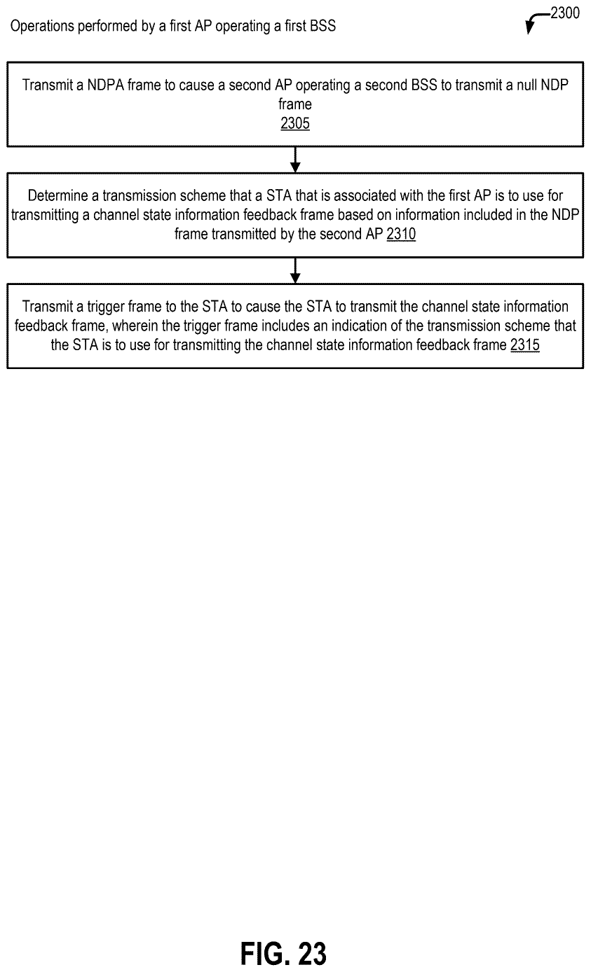

Turning now to FIG. 23, a method 2300 will be described for performing an OBSS channel sounding procedure, in accordance with an example embodiment. The method 2300 may be performed by a first AP operating a first BSS (e.g., AP1 in the first phase (BSS1 STA(s) being sounded phase) shown in FIG. 16). The first AP may be implemented by a wireless device (e.g., wireless device 104).

At operation 2305, the first AP transmits a NDPA frame to cause a second AP operating a second BSS to transmit a null NDP frame.

At operation 2310, the first AP determines a transmission scheme that a STA that is associated with the first AP is to use for transmitting a channel state information feedback frame based on information included in the NDP frame transmitted by the second AP. In an embodiment, the transmission scheme comprises a MCS and a number of spatial streams. In an embodiment, the information included in the NDP frame transmitted by the second AP includes a SNR of a link between the STA and the second AP or an indication of the transmission scheme that the STA is to use for transmitting the channel state information feedback frame. In an embodiment, the information is included in bits B11-B15 of a common field included in an EHT-SIG field of the NDP frame. In an embodiment, the information is included in bits B10-B15 of a common field included in an EHT-SIG field of the NDP frame. In this embodiment, a number of spatial streams field included in the common field may have a length of three bits (instead of the customary length of four bits). In an embodiment, a common field included in an EHT-SIG field of the NDP frame includes an OBSS sounding NDP indication field that includes an indication that the NDP frame is an OBSS sounding NDP frame, wherein the EHT-SIG field further includes a user-specific field, wherein the information is included in the user-specific field. In an embodiment, the OBSS sounding NDP indication field occupies bit B14 of the common field, wherein a disregard field included in the common field of the NDP frame has a length of one bit (instead of the customary two bits). In an embodiment, the OBSS sounding NDP indication field occupies bit B12 of the common field, wherein a number of spatial streams field included in the common field has a length of three bits (instead of the customary four bits).

At operation 2315, the first AP transmits a trigger frame to the STA to cause the STA to transmit the channel state information feedback frame, wherein the trigger frame includes an indication of the transmission scheme that the STA is to use for transmitting the channel state information feedback frame. In an embodiment, the trigger frame is a BFRP frame and the channel state information feedback frame is a CB/CQI frame. The channel state information feedback frame may be intended for the second AP (for the second AP to obtain channel state information for the link between the STA and the second AP).

In an embodiment, prior to transmitting the NDPA frame, the first AP transmits a second NDPA frame followed by a second NDP frame. The first AP may then transmit a second trigger frame to the STA to cause the STA to transmit a second channel state information feedback frame, wherein the second AP determines an estimated link quality of a link between the STA and the second AP based on the second channel state information feedback frame, wherein the second AP generates the information included in the NDP frame based on the estimated link quality of the link between the STA and second AP.

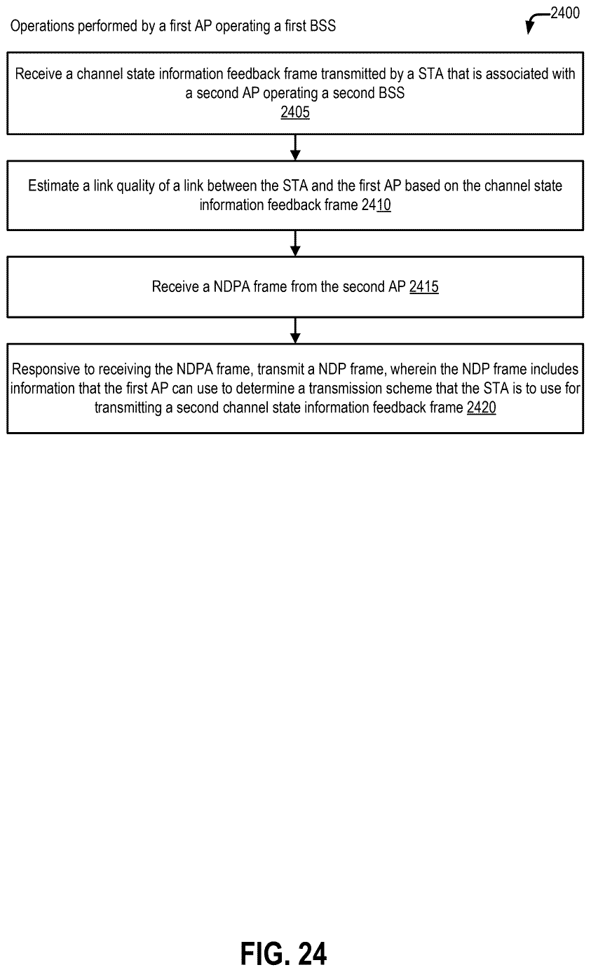

Turning now to FIG. 24, a method 2400 will be described for performing an OBSS channel sounding procedure, in accordance with an example embodiment. The method 2400 may be performed by a first AP operating a first BSS (e.g., AP2 in the first phase (BSS1 STA(s) being sounded phase) shown in FIG. 16). The first AP may be implemented by a wireless device (e.g., wireless device 104).

At operation 2405, the first AP receives a channel state information feedback frame transmitted by a STA that is associated with a second AP operating a second BSS.

At operation 2410, the first AP estimates a link quality of a link between the STA and the first AP based on the channel state information feedback frame.

At operation 2415, the first AP receives a NDPA frame from the second AP.

At operation 2420, responsive to receiving the NDPA frame, the first AP transmits a NDP frame, wherein the NDP frame includes information that the first AP can use to determine a transmission scheme that the STA is to use for transmitting a second channel state information feedback frame. In an embodiment, the transmission scheme comprises a MCS and a number of spatial streams. In an embodiment, the information included in the NDP frame includes a SNR of the link between the STA and the first AP or an indication of the transmission scheme that the STA is to use for transmitting the second channel state information feedback frame. In an embodiment, the information is included in bits B11-B15 of a common field included in an EHT-SIG field of the NDP frame. In an embodiment, the information is included in bits B10-B15 of a common field included in an EHT-SIG field of the NDP frame. In such an embodiment, a number of spatial streams field included in the common field may have a length of three bits (instead of the customary four bits). In an embodiment, a common field included in an EHT-SIG field of the NDP frame includes an OBSS sounding NDP indication field that includes an indication that the NDP frame is an OBSS sounding NDP frame, wherein the EHT-SIG field further includes a user-specific field, wherein the information is included in the user-specific field. In an embodiment, the OBSS sounding NDP indication field occupies bit B14 of the common field, wherein a disregard field included in the common field has a length of one bit (instead of the customary two bits). In an embodiment, the OBSS sounding NDP indication field occupies bit B12 of the common field, wherein a number of spatial streams field included in the common field has a length of three bits (instead of the customary four bits). The STA may use the NDP frame to determine channel state information for the link between the STA and the first AP and include this channel state information in the second channel state information feedback frame.

In an embodiment, the channel state information feedback frame and the second channel state information feedback frame are CB/CQI frames.

In an embodiment, an AP may perform method 2300 during one phase of an OBSS channel sounding procedure and perform method 2400 during another phase of the OBSS channel sounding procedure.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microelectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a first access point (AP) operating a first basic service set (BSS) to perform an overlapping basic service set (OBSS) channel sounding procedure, the method comprising:
transmitting a null data packet announcement (NDPA) frame to cause a second AP operating a second BSS to transmit a null data packet (NDP) frame;
determining a transmission scheme that a station (STA) that is associated with the first AP is to use for transmitting a channel state information feedback frame based on information included in the NDP frame transmitted by the second AP; and
transmitting a trigger frame to the STA to cause the STA to transmit the channel state information feedback frame, wherein the trigger frame includes an indication of the transmission scheme that the STA is to use for transmitting the channel state information feedback frame.

2. The method of claim 1, further comprising:
prior to transmitting the NDPA frame:
transmitting a second NDPA frame followed by a second NDP frame; and
transmitting a second trigger frame to the STA to cause the STA to transmit a second channel state information feedback frame, wherein the second AP determines an estimated link quality of a link between the STA and the second AP based on the second channel state information feedback frame, wherein the second AP generates the information included in the NDP frame based on the estimated link quality of the link between the STA and second AP.

3. The method of claim 2, wherein the transmission scheme comprises a modulation coding scheme (MCS) and a number of spatial streams.

4. The method of claim 1, wherein the information included in the NDP frame transmitted by the second AP includes a signal-to-noise ratio (SNR) of a link between the STA and the second AP or an indication of the transmission scheme that the STA is to use for transmitting the channel state information feedback frame.

5. The method of claim 1, wherein the information is included in bits B11-B15 of a common field included in an extremely high throughput signal (EHT-SIG) field of the NDP frame.

6. The method of claim 1, wherein the information is included in bits B10-B15 of a common field included in an extremely high throughput signal (EHT-SIG) field of the NDP frame.

7. The method of claim 6, wherein a number of spatial streams field included in the common field has a length of three bits.

8. The method of claim 1, wherein a common field included in an extremely high throughput signal (EHT-SIG) field of the NDP frame includes an OBSS sounding NDP indication field that includes an indication that the NDP frame is an OBSS sounding NDP frame, wherein the EHT-SIG field further includes a user-specific field, wherein the information is included in the user-specific field.

9. The method of claim 8, wherein the OBSS sounding NDP indication field occupies bit B14 of the common field, wherein a disregard field included in the common field of the NDP frame has a length of one bit.

10. The method of claim 8, wherein the OBSS sounding NDP indication field occupies bit B12 of the common field, wherein a number of spatial streams field included in the common field has a length of three bits.

11. A method performed by a first access point (AP) operating a first basic service set (BSS) to perform an overlapping basic service set (OBSS) channel sounding procedure, the method comprising:
receiving a channel state information feedback frame transmitted by a station (STA) that is associated with a second AP operating a second BSS;
estimating a channel quality of a link between the STA and the first AP based on the channel state information feedback frame;
receiving a null data packet announcement (NDPA) frame from the second AP; and
responsive to receiving the NDPA frame, transmitting a null data packet (NDP) frame, wherein the NDP frame includes information that the first AP can use to determine a transmission scheme that the STA is to use for transmitting a second channel state information feedback frame.

12. The method of claim 11, wherein the transmission scheme comprises a modulation coding scheme (MCS) and a number of spatial streams.

13. The method of claim 11, wherein the information included in the NDP frame includes a signal-to-noise ratio (SNR) of the link between the STA and the first AP or an indication of the transmission scheme that the STA is to use for transmitting the second channel state information feedback frame.

14. The method of claim 11, wherein the information is included in bits B11-B15 of a common field included in an extremely high throughput signal (EHT-SIG) field of the NDP frame.

15. The method of claim 11, wherein the information is included in bits B10-B15 of a common field included in an extremely high throughput signal (EHT-SIG) field of the NDP frame.

16. The method of claim 15, wherein a number of spatial streams field included in the common field has a length of three bits.

17. The method of claim 11, wherein a common field included in an extremely high throughput signal (EHT-SIG) field of the NDP frame includes an OBSS sounding NDP indication field that includes an indication that the NDP frame is an OBSS sounding NDP frame, wherein the EHT-SIG field further includes a user-specific field, wherein the information is included in the user-specific field.

18. The method of claim 17, wherein the OBSS sounding NDP indication field occupies bit B14 of the common field, wherein a disregard field included in the common field has a length of one bit.

19. The method of claim 17, wherein the OBSS sounding NDP indication field occupies bit B12 of the common field, wherein a number of spatial streams field included in the common field has a length of three bits.

20. A wireless device configured to implement a first access point (AP) that is to operate a first basic service set (BSS), the wireless device comprising:
a radio frequency transceiver;
a memory device storing a set of instructions; and
a processor coupled to the memory device, wherein the set of instructions, when executed by the processor, causes the first AP to:
transmit a null data packet announcement (NDPA) frame to cause a second AP operating a second BSS to transmit a null data packet (NDP) frame;
determine a transmission scheme that a station (STA) that is associated with the first AP is to use for transmitting a channel state information feedback frame based on information included in the NDP frame transmitted by the second AP; and
transmit a trigger frame to the STA to cause the STA to transmit the channel state information feedback frame, wherein the trigger frame includes an indication of the transmission scheme that the STA is to use for transmitting the channel state information feedback frame.

21. A wireless device configured to implement a first access point (AP) that is to operate a first basic service set (BSS), the wireless device comprising:
a radio frequency transceiver;
a memory device storing a set of instructions; and
a processor coupled to the memory device, wherein the set of instructions, when executed by the processor, causes the first AP to:
receive a channel state information feedback frame transmitted by a station (STA) that is associated with a second AP operating a second BSS;
estimate a channel quality of a link between the STA and the first AP based on the channel state information feedback frame;
receive a null data packet announcement (NDPA) frame from the second AP; and
responsive to receiving the NDPA frame, transmit a null data packet (NDP) frame, wherein the NDP frame includes information that the first AP can use to determine a transmission scheme that the STA is to use for transmitting a second channel state information feedback frame.
